(19) United States
(12) Patent Application Publication
(10) Pub. No.: US 2006/0081515 A1
(43) Pub. Date: Apr. 20, 2006

(54) Two-stage particle-size analyzer

(76) Inventors: Boris Z Gorbunov, Kent (GB); Nicholas D Priest, Oxfordshire (GB)

Correspondence Address: Ronald B Sherer;Bartlett & Sherer, 103 South Shaffer Drive, New Freedom, PA, 17349, US

(21) Appl. No.: 10/519,340

(22) PCT Filed: Jun. 30, 2003
(86) PCT No.: PCT/GB03/02775

§ 371 Date: Jul. 25, 2005

(30) Foreign Application Priority Data
Jun. 28, 2002 (GB) 0215003.5

(51) Int. Cl. B07B 13/05; B07B 13/07; B07C 5/12

(52) U.S. Cl. 209/675; 209/660

(57) ABSTRACT

A particle collector and sampler for use with aerosols which has a first collector for larger particles and a second a collector which is a net collector for smaller particles. The system includes humidity control.

The present invention relates to a method and apparatus for collecting particles suspended in a fluid.

Collecting the particulate matter suspended in a fluid, e.g. air, is an important stage of air quality assessment, atmospheric science and aerosol technology, and particles collected from a fluid are analysed by various chemical and physical methods for particulate matter characterisation.

There are two methods of particle characterisation (i) bulk analysis and (ii) size selective analysis. The latter usually involves describing the particle size distributions and so the size selective collection of particles is an important stage in their characterisation and the present invention relates to the size selection of particles.

A known method of characterising aerosol particles size distributions is based on the deposition of particles onto substrates in a cascade impactor and further analysis of the deposits (e.g. by gravimetrical or chemical analysis). In a cascade impactor particles of different sizes are collected onto different substrates due to the difference in their inertia. The selectivity of deposition is achieved by means of a number of air jets with specific aerodynamic characteristics. Each stage of an impactor has a different jet facing the substrate where particles ae collected. Thus, an impactor enables a set of mass concentrations in various size ranges (size sections) to be obtained.

Usually a cascade impactor is used to collect particles larger than 0.3 μm. This method has a limitation and it is very difficult to apply it to particles smaller than 0.3 μm.

Another method relevant to obtaining aerosol size distributions is the deposition of aerosol particles onto a fibre or membrane filter. In this method a size selective inlet is often used to remove particles larger than a certain size, e.g. 10 μm. All particles passed through the inlet are collected onto a filter and are analysed later. This method is simpler to use than cascade impactors. Various size selective inlets are used along with a filter to sample the mass faction of an aerosol; for instance PM₁₀, PM_{2.5} or PM₁ (where the figure indicates the cut off aerodynamic diameter of the inlet). The filter method enables a wide range of particles to be collected, even particles smaller than 0.3 μm. However it has a limited capability for obtaining information about particle sizes and, in particular, the major drawback of this method is its inability to deliver the size resolved information so size distributions of the particulate matter cannot be obtained with this technique.

We have devised an improved method and apparatus for collecting particles from a fluid.

According to the invention there is provided a method for selective deposition of suspended particles from a fluid which method comprises passing the fluid sequentially over a first collector adapted to collect larger particles and then over a second collector adapted to collect smaller particles, which second collector comprises a chamber in which there is at least one net or another material containing fibres placed across the chamber.

The invention also provides a particle collector for collecting and sampling particles in a fluid which comprises sequentially (i) an inlet, (ii) a first collector adapted to collect larger particles and (iii) a second collector adapted to collect smaller particles comprising a chamber in which there is at least one net placed across the chamber and a flows means able to sustain a flow of fluid sequentially through the inlet, first collector and second collector.

The nets can be any structure which has the equivalent effect to nets, e.g. can be woven, knitted or formed of fibres so that the effect is similar to nets in removing particles; for example they can also be rigid or semi rigid.

By larger particles is meant particles larger than those collected in the second collector. In general this will mean particles of sizes above about 0.3 μm.

There optionally can be further collecting media through which the fluid subsequently will flow in use.

Preferably the first collector comprises a cascade impactor or a sedimentation cell, e.g. containing set of parallel horizontal partitions.

The second collection collector can comprise at least one net and preferably at least two nets of different mesh sizes mounted within a container, so that the fluid passes sequentially through the nets. There can be tree, four, five or more nets.

Thus, particles of different sizes are collected on different nets. In a four net construction for example the first net faces the flow and collects the largest particles, e.g. greater than 100 nm; the particles smaller than 10 nm penetrate through the first net; the second net collects the particles in the size range from 10 to 30 nm; the particles smaller than 30 nm but larger than 10 nm penetrate through the second net and they are collected by the third net; particles smaller than 10 nm (e.g. from 1 to 10 nm) are collected by the fourth net.

The nets can be either-identical or different. Different nets can be used to increase the size range of particles to be deposited. For example the first net can have a mesh opening of 120 μm; the second net can have a mesh opening of 40 μm; the third net can have a mesh opening of 20 μm and the fourth net can have a mesh opening of 10 μm.

The net sampling is applicable only for sub-micron size particles, for instance for particles smaller than about 0.3 μm. So the first collecting collector preferably collects particles above this size.

When a sedimentation cell with a plurality of partitions is used as the first collector, the particles are separated due to gravitational settling onto the partitions and can be analysed later. The sedimentation of particles depends on their size. Thus analyzing the different parts of the pile of partitions make it possible to obtain additional information about the size distribution of the particles.

Preferably the collection of particles on the net(s) takes place at controlled humidity and preferably there is a humidity control unit which is incorporated between the inlet and the large particle collector.

The invention is suitable for use with aerosols and, in use with an aerosol the aerosol particles are introduced into the inlet and after that go into the first section of the first collector (e.g. the first stage of the cascade impactor). A fraction of particles of the higher collection ability is collected by the first stage. The rest of the particles goes further with the flow and is deposited onto the next stages. Every stage collects particles of certain sizes. After passing all the stages of the cascade impactor, the flow goes into the net sampler where smaller particles are deposited according to their efficiency. A fraction of particles of the higher collection ability is collected by the first net. The rest of particles goes feather and is collected by the next nets.

The invention enables there to be delivered size resolved information so a much more accurate method size distribution of the particulate matter can be obtained with this technique and it was very surprising that the combination of the two different separators gives such improved results.

The invention is illustrated in the accompanying drawings in which

FIG. 1 shows an existing collector,

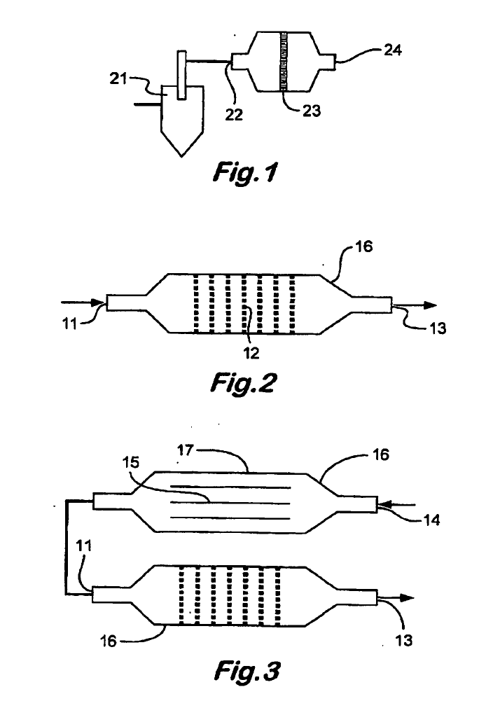

FIG. 2 shows schematically a net collector which can be used,

FIG. 3 shows schematically a simple collector according to the invention and

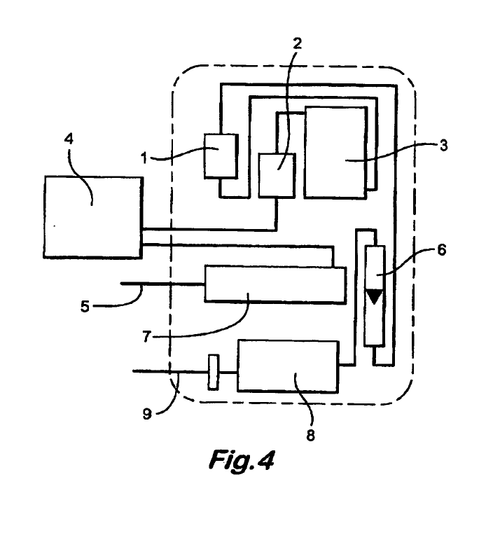

FIG. 4 shows schematically a more detailed collector according to the invention.

Referring to FIG. 1, existing collectors for use with aerosols comprise a size selective preseparator (21) (e.g. a cyclone with 10 μm cut off aerodynamic size), inlet (22), filter (23) and outlet (24).

In use the aerosol passes through cyclone preseparator (21) which collects particles above 10 μm and the aerosol particles pass through inlet (22) and are then deposited onto a fibre or membrane filter (23) and the air then passes out through outlet (24). All the particles which have passed through the inlet are collected onto the filter and are analysed later.

Referring to FIG. 2 which shows a net collector, there is a container (16) with inlet (11), nets (12) and outlet (13). In use particles of different sizes are collected on different nets. Seven nets are shown for illustration with the first net facing the flow, but in a four net construction; for example the first net faces the flow and collects the largest particles e.g. greater than 100 nm; the particles smaller than 10 nm penetrate through the first net; the second net collects the particles in the size range from 10 to 30 nm; the particles smaller than 30 nm but larger than 10 nm penetrate though the second net and they are collected by the third net; particles smaller than 100 ml (e.g. from 1 to 10 nm) are collected by the fourth net. The particles can be removed from the net and analysed which makes it possible to obtain additional information about the size distribution of aerosol particles.

Referring to FIG. 3 there is a sedimentation cell (17) containing horizontal partitions (15) and inlets and outlets (14), (11), and (13).

In use the particles are separated in separtor (17) due to gravitational settling onto the partitions (15) and these particles can be analysed later. The sedimentation of particles depends on their size. Thus analysing the different parts of the pile of partitions makes it possible to obtain additional information about the size distribution of aerosol particles. After leaving (17) the fluid passes through inlet (1) to net separator (16) which functions are as described in FIG. 2.

Referring to FIG. 4, this illustrates a wide range of aerosol samplers designed to collect selectively aerosol particles in a wide range of sizes from 1 nm to 30 μm aerodynamic diameter under a constant controlled humidity. The flow rate is from 1 to 30 l/min and the sampling humidity (inside the sampling system) is from 30 to 95%.

The collector and sampling system consists of a net sampler (1), humidity control unit (2), cascade impactor (3), aerosol chamber (4), inlet (5), flow meter (6), saturator (7), pump (8) and outlet (9) with aerosol filter.

In use this system provides sampling under a constant humidity that could be set using the humidity control unit button on humidity control unit (2). Aerosol enters the saturator (7) through the inlet (5). After the saturator the aerosol goes into the aerosol chamber (4) where water vapour condenses onto particles. The chamber (4) is connected to the humidity control unit (2). If humidity is lower than required the heater in the saturator is turned on by the humidity controller. It gives more water vapour and humidity is increased.

After the humidity control unit (2) aerosol enters the cascade impactor (3) where particles larger than 0.25 μm are collected onto impactor slides: Microscope Slides (Size 76×26 mm; thickness 1.0-1.2 mm). The particles smaller than 0.25 μm are then collected by the net sampler (1). The particles can then be analysed according to their size and the size distribution is calculated

The Cascade Impactor

The size bands of a cascade impactor are influenced by the flow rate. At the flow rate 20 l/min 50% particle retention efficiency, aerodynamic diameters are shown in Table 1.

TABLE 1
50% Particle Retention Efficiency aerodynamic diameters
for May cascade impactor used in the prototype

| | Impactor stage number | | | | | | |
|---|---|---|---|---|---|---|---|
| | 1 | 2 | 3 | 4 | 5 | 6 | 7 |
| 50% Particle retention | 20 | 8 | 4 | 2 | 1 | 0.5 | 0.25 |
| efficiency aerodynamic | | | | | | | |
| diameter, μm | | | | | | | |

The Net Sampler

There are two options shown as examples:
(i) the basic configuration of the net sampler with 4 size sections and
(ii) 8-section net sampler.

At the flow rate 20 l/min maximal collection efficiency aerodynamic diameters for the basic configuration of the net sampler are shown in Table 2.

TABLE 2
Maximal collection efficiency aerodynamic diameters
for the basic configuration of the net sampler

| | Net sampler section number | | | |
|---|---|---|---|---|
| | 1 | 2 | 3 | 4 |
| Maximal collection | 128 | 32 | 8 | 2 |
| efficiency aerodynamic | (0.128) | (0.032) | (0.008) | (0.002) |
| diameter, nm and (μm) | | | | |

Maximal collection efficiency aerodynamic diameters (at the flow rate 20 l/min) for 8-section net sampler are shown in Table 3.

TABLE 3
Maximal collection efficiency aerodynamic
diameters for 8-section net sampler

| | Net sampler section number | | | | | | | |
|---|---|---|---|---|---|---|---|---|
| | 1 | 2 | 3 | 4 | 5 | 6 | 7 | 8 |
| Maximal collection | 128 | 64 | 32 | 16 | 8 | 4 | 2 | 1 |
| efficiency | | | | | | | | |
| aerodynamic diameter, | | | | | | | | |
| nm | | | | | | | | |

The deposits on nets can be analysed separately. The size distribution of an aerosol is determined from chemical analysis or gravimetrical measurements.

1-14. (canceled)

15. A particle collector for collecting and sampling particles in a fluid which comprises sequentially (i) an inlet (ii) a first collector adapted to collect larger particles and (iii) a second collector adapted to collect smaller particles which second collector comprises a chamber in which there is at least one net or another material containing fibres placed across the chamber and a flow means able to sustain a flow of fluid sequentially through the inlet, first collector and second collector.

16. A particle collector according to claim 15 in which the first collector is adapted to collect particles larger than 0.3 □m and the second collector is adapted to collect particles smaller than 0.3 □m.

17. A particle collector according to claim 15 in which there is a humidity control unit incorporated between the inlet and the large particle collector.

18. A particle collector according to claim 17 in which the humidity control unit comprises a heater and a humidity sensor.

19. A particle collector according to claim 15 in which the first collector is selected from a cascade impactor, a plurality of cascade impactors in sequence, a sedimentation unit, a multi stage sedimentation unit, a cyclone and an array of a plurality of cyclones.

20. A particle collector according to claim 15 in which said net contains a plurality of nets with different mesh openings.

21. A particle collector according to claim 20 in which there are a plurality of said nets operating under different flow-rates.

22. A particle collector according to claim 20 in which two or more nets are assembled in parallel or sequentially.

23. A particle collector according to claim 20 in which one or several nets are employed to collect large particles.

24. A particle collector according to claim 15 in which there is a saturator located upstream of the first collector.

25. A particle collector according to claim 15 in which the fluid is dragged through the collector by a higher pressure generating means.

26. A particle collector according to claim 15 in which there are is an optical particle counter, a dust monitor, nephelometer, aethelometer or a condensation particle counter for obtaining particle size distributions without chemical or gravimetrical analysis.

27. A particle collector according to claim 15 in combination with an ionisation unit and a mobility selective element.

28. A particle collector according to claim 27 in which there an aerosol neutroliser placed between the mobility selective element and the net sampler.

29. A method for selective deposition of suspended particles from a fluid which method comprises (i) passing the fluid sequentially over a first collector adapted to collect larger particles and (ii) over a second collector adapted to collect smaller particles, which second collector comprises a chamber in which there is at least one net or another material containing fibres placed across the chamber.

30. A method for selective deposition of suspended particles according to claim 29 in which the first collector collects particles larger than 0.3 □m and the second collector collects particles smaller than 0.3 □m.

31. A method for selective deposition of suspended particles according to claim 29 in which the first collector is selected from a cascade impactor, a plurality of cascade impactors in sequence, a sedimentation unit, a multi stage sedimentation unit, a cyclone and an array of a plurality of cyclones.

32. A particle collector according to claim 29 in which the net sampler contains a plurality of nets with different mesh openings.

33. A method according to claim 29 in which there is a saturator located upstream of the first collector.

34. A method according to claim 33 in which the larger particles are ionised and deposited in an electric field.

35. A method according to claim 34 in which the charge on the particles is reduced by a neutralisation unit placed between the first collector and the second collector.
